(19) United States
(12) Patent Application Publication
(10) Pub. No.: US 2015/0343845 A1
(43) Pub. Date: Dec. 3, 2015

(54) CORE OF NON-PNEUMATIC TIRE AND METHOD OF FORMING CORE

(71) Applicant: Caterpillar Inc., Peoria, IL (US)

(72) Inventors: Christopher A. Kinney, Luka, MS (US); Larry D. Bright, Walnut, MS (US); Nathaniel B. Null, Corinth, MS (US); Robert C. Claburn, Michie, TN (US)

(73) Assignee: Caterpillar Inc., Peoria, IL (US)

(21) Appl. No.: 14/294,916

(22) Filed: Jun. 3, 2014

(51) Int. Cl. B60C 7/00; B23B 5/28

(52) U.S. Cl. CPC B60C 7/00; B23B 5/28; B23B 2215/08

(57) ABSTRACT

A core of a non-pneumatic tire is configured to have a tread formed thereon. The core may include an inner circumferential portion associated with a hub, and an outer circumferential portion radially spaced from the inner circumferential portion. The core may further include a support structure extending between the inner circumferential portion and the outer circumferential portion. The support structure may include a plurality of first ribs, and at least some of the first ribs at least partially form cavities in the support structure. The core may also be substantially absent of tread, such that an outer circumferential portion has a radially outward facing surface having a substantially constant diameter spanning between side edges of the outer circumferential portion.

### TECHNICAL FIELD

The present disclosure relates to cores of non-pneumatic tires and methods of forming the cores, and more particularly, to cores configured to have a tread formed thereon and methods of forming such cores.

### BACKGROUND

Machines such as vehicles often include tires for facilitating travel across terrain. Such tires often include a rim or hub, provide cushioning for improved comfort or protection of passengers or cargo, and provide enhanced traction via a tread of the tire. Non-pneumatic tires are an example of such tires. For example, non-pneumatic tires may be formed by supplying a material in a flowable form into a mold and after the material hardens, removing the molded tire from the mold. Such tires may be molded so that the tread is formed during the molding of the tire, such that the tire is a single, monolithic structure including the tread.

Use of such tires may result in the tread wearing down to a point rendering the tire unsuitable for its intended use. For a pneumatic tire, it is possible to merely remove the rubber tire portion from the wheel, and install a new rubber tire portion onto the wheel and inflate it, thereby acquiring a new tire having a desirable tread. However, unlike a pneumatic tire that is mounted on a wheel and inflated, it may be difficult or impractical to simply remove the portion of the non-pneumatic tire surrounding a hub and install a new portion having tread, particularly if the non-pneumatic tire is molded as a single, monolithic structure.

Therefore, it may be desirable to provide a new tread on a non-pneumatic tire without discarding the remainder of the tire and forming a new tire. Thus, it may be desirable to provide a method for removing the worn tread of a non-pneumatic tire, such that the remaining tire structure may be provided in a condition that permits the molding of a new tread on the remainder of the tire.

An example of an apparatus and method for removing a portion of the crown of a worn pneumatic tire is described in U.S. Pat. No. 3,426,828 to Neilson (“the '828 patent”). According to the '828 patent, the crown portion is removed in preparation for application of tread stock in a tire recapping process. The '828 patent describes a process in which an inflated tire is rotated on its axis at a predetermined speed, and a knife-type cutter traverses the crown of the tire to remove a portion of the crown.

Although the apparatus and method disclosed in the '828 patent purport to result in removing a portion of a crown of a pneumatic tire, it does not relate to removing at least a portion of tread from a non-pneumatic tire in a manner that renders the remaining portion of the non-pneumatic suitable for having tread molded onto the remaining portion. Thus, the apparatus and method described in the '828 patent may be unsuitable for non-pneumatic tires.

The core and method of forming a core disclosed herein may be directed to mitigating or overcoming one or more of the possible drawbacks set forth above.

### SUMMARY

According to a first aspect, the present disclosure is directed to a core of a non-pneumatic tire, wherein the core is configured to have a tread formed thereon. The core may include a hub configured to be coupled to a machine, an inner circumferential portion associated with the hub, and an outer circumferential portion radially spaced from the inner circumferential portion. The outer circumferential portion extends between opposed, axially-spaced side edges. The core may further include a support structure extending between the inner circumferential portion and the outer circumferential portion and coupling the inner circumferential portion to the outer circumferential portion. The support structure may include a plurality of first ribs extending between the inner circumferential portion and the outer circumferential portion, and at least some of the first ribs at least partially form cavities in the support structure. The core may also be substantially absent of tread including a predetermined pattern of at least one of protrusions and recesses, such that the outer circumferential portion has a radially outward facing surface having a substantially constant diameter spanning between the side edges of the outer circumferential portion.

According to a further aspect, the disclosure is directed to a core of a non-pneumatic tire, with the core being configured to have a tread formed thereon. The core may include a hub configured to be coupled to a machine, an inner circumferential portion associated with the hub, and an outer circumferential portion radially spaced from the inner circumferential portion. The outer circumferential portion extends between opposed, axially-spaced side edges. The core may further include a support structure extending between the inner circumferential portion and the outer circumferential portion and coupling the inner circumferential portion to the outer circumferential portion. The support structure may include a plurality of first ribs extending between the inner circumferential portion and the outer circumferential portion, and at least some of the first ribs at least partially form cavities in the support structure. At least some of the cavities in the support structure are adjacent the outer circumferential portion, such that a radially outward facing surface of the core includes alternating regions that are relatively more flexible and relatively less flexible.

According to another aspect, the present disclosure is directed to a method of forming a core of a non-pneumatic tire, with the core being configured to have a tread formed thereon. The method may include mounting a non-pneumatic tire in a lathe, and activating the lathe such that the tire rotates about an axis of rotation of the tire. The method may further include applying a cutter against a surface of the tire such that the cutter removes material from the tire. The method may further include continuing to apply the cutter against the tire until an outer circumferential portion of the tire has a radially outward facing surface having a substantially constant diameter spanning between opposed, axially-spaced side edges of the outer circumferential portion.

### BRIEF DESCRIPTION OF THE DRAWINGS

FIG. 1 is a side view of an exemplary embodiment of a machine including an exemplary embodiment of a molded tire.

FIG. 2 is a perspective view of an exemplary embodiment of a molded tire.

FIG. 3 is a partial section view of an exemplary embodiment of a molded tire.

FIG. 4 is a partial section view of another exemplary embodiment of a molded tire.

FIG. 5 is a perspective view of an exemplary machine for forming a core of a non-pneumatic tire according to an exemplary method.

FIG. 6 is a perspective view of an exemplary machine for forming a core of a non-pneumatic tire according to another exemplary method.

FIG. 7 is a perspective view of an exemplary embodiment of a core of a non-pneumatic tire.

FIG. 8 is a partial section view of an exemplary embodiment of a core.

FIG. 9 is a partial section view of another exemplary embodiment of a core.

### DETAILED DESCRIPTION

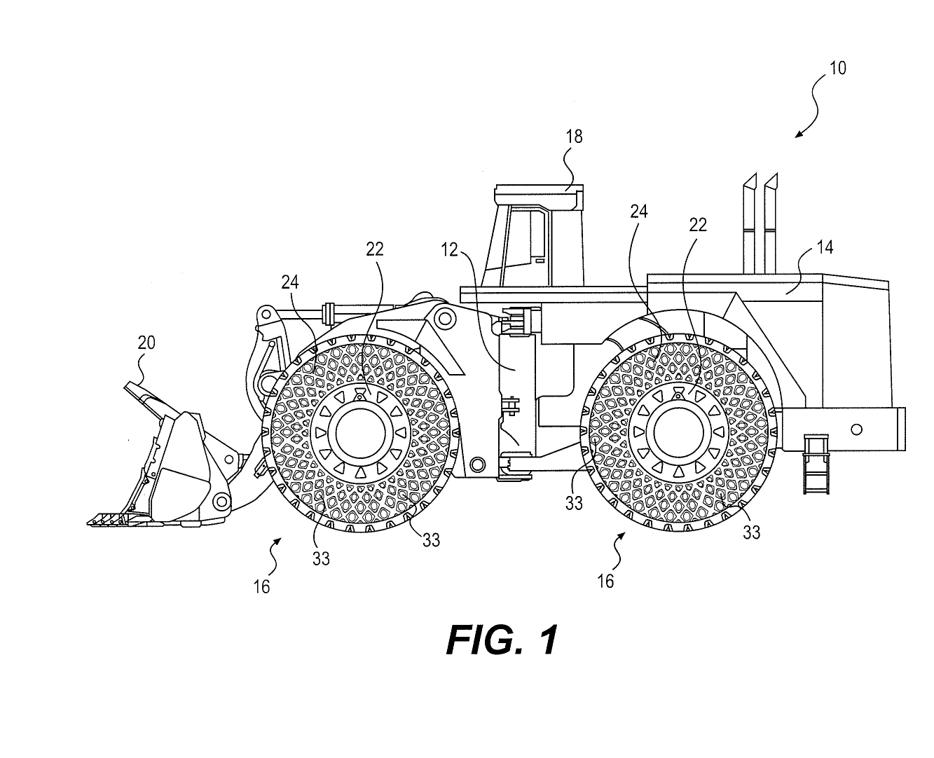

FIG. 1 shows an exemplary machine 10 configured to travel across terrain. Exemplary machine 10 shown in FIG. 1 is a wheel loader. However, machine 10 may be any type of ground-borne vehicle, such as, for example, an automobile, a truck, an agricultural vehicle, and/or a construction vehicle, such as, for example, a dozer, a skid-steer loader, an excavator, a grader, an on-highway truck, an off-highway truck, and/or any other vehicle type known to a person skilled in the art. In addition to self-propelled machines, machine 10 may be any device configured to travel across terrain via assistance or propulsion from another machine.

Exemplary machine 10 shown in FIG. 1 includes a chassis 12 and a powertrain 14 coupled to and configured to supply power to wheels 16, so that machine 10 is able to travel across terrain. Machine 10 also includes an operator station 18 to provide an operator interface and protection for an operator of machine 10. Machine 10 also includes a bucket 20 configured to facilitate movement of material. As shown in FIG. 1, exemplary wheels 16 include a hub 22 coupled to powertrain 14, and tires 24 coupled to hubs 22. Exemplary tires 24 are molded tires, such as, for example, molded, non-pneumatic tires.

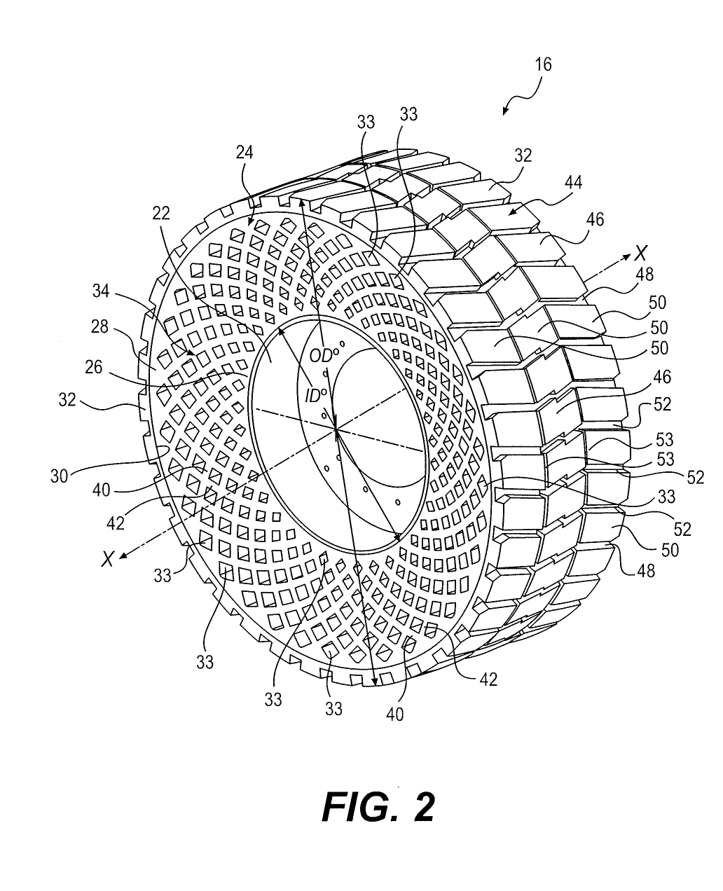

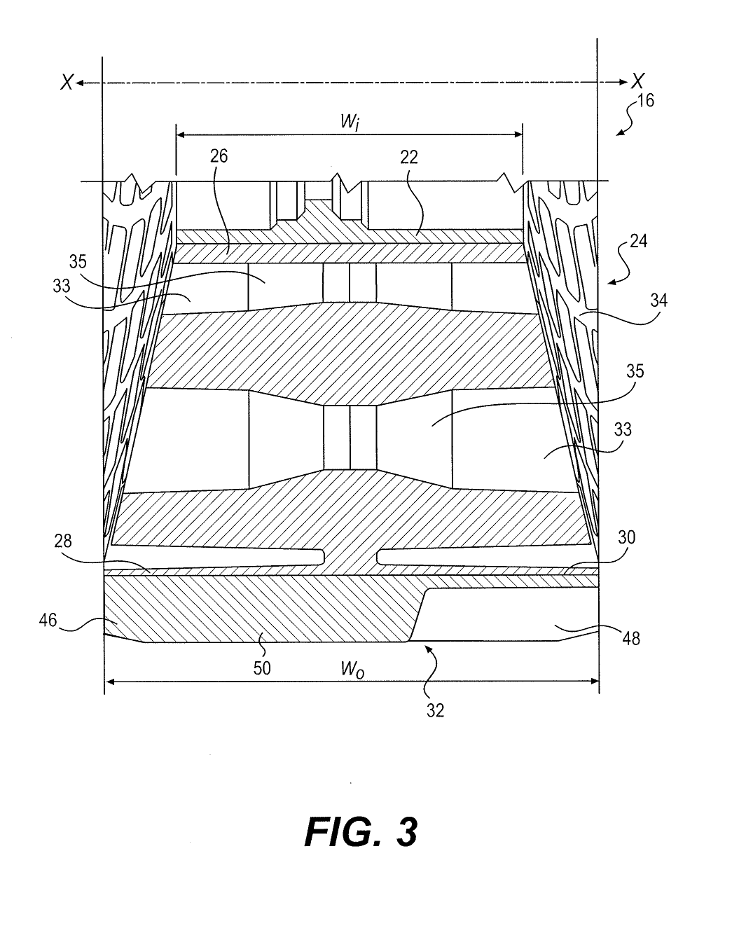

The exemplary tire 24 shown in FIGS. 2 and 3 includes an inner circumferential portion 26 configured to be coupled to a hub 22, and an outer circumferential portion 28 configured to be coupled to an inner surface 30 of a tread portion 32 configured to improve traction of tire 24 at the interface between tire 24 and the terrain across which tire 24 rolls. Extending between inner circumferential portion 26 and outer circumferential portion 28 is a support structure 34. Exemplary support structure 34 serves to couple inner circumferential portion 26 and outer circumferential portion 28 to one another. As shown in FIGS. 1-4, exemplary tire 24 includes a plurality of cavities 33 configured to provide support structure 34 with a desired level of support and cushioning for tire 24. According to some embodiments, one or more of cavities 33 may have an axial intermediate region 35 having a relatively smaller cross-section than the portion of cavities 33 closer to the axial sides of tire 24.

According to some embodiments, one or more of inner circumferential portion 26 and outer circumferential portion 28 are part of support structure 34. Hub 22 and/or inner circumferential portion 26 may be configured to facilitate coupling of hub 22 to inner circumferential portion 26. According to some embodiments, support structure 34, inner circumferential portion 26, outer circumferential portion 28, and/or tread portion 32 are integrally formed as a single, monolithic piece, for example, via molding. For example, tread portion 32 and support structure 34 may be chemically bonded to one another. For example, the material of tread portion 32 and the material of support structure 34 may be covalently bonded to one another. According to some embodiments, support structure 34, inner circumferential portion 26, and/or outer circumferential portion 28 are integrally formed as a single, monolithic piece, for example, via molding, and tread portion 32 is formed separately in time and/or location and is joined to support structure 34 in a common mold assembly to form a single, monolithic piece. Even in such embodiments, tread portion 32 and support structure 34 may be chemically bonded to one another. For example, the material of tread portion 32 and the material of support structure 34 may be covalently bonded to one another.

Exemplary tire 24, including inner circumferential portion 26, outer circumferential portion 28, tread portion 32, and support structure 34, may be configured to provide a desired amount of traction and cushioning between a machine and the terrain. For example, support structure 34 may be configured to support the machine in a loaded, partially loaded, and empty condition, such that a desired amount of traction and/or cushioning is provided, regardless of the load.

For example, if the machine is a wheel loader as shown in FIG. 1, when its bucket is empty, the load on one or more of wheels 16 may range from about 60,000 lbs. to about 160,000 lbs. (e.g., 120,000 lbs.). In contrast, with the bucket loaded with material, the load on one or more of wheels 16 may range from about 200,000 lbs. to about 400,000 lbs. (e.g., 350,000 lbs.). Tire 24 may be configured to provide a desired level of traction and cushioning, regardless of whether the bucket is loaded, partially loaded, or empty. For smaller machines, correspondingly lower loads are contemplated. For example, for a skid-steer loader, the load on one or more of wheels 16 may range from about 1,000 lbs. empty to about 3,000 lbs. (e.g., 2,400 lbs.) loaded.

Exemplary support structure 34 shown in FIG. 2 has a plurality of first ribs 40 extending in a first circumferential direction between inner circumferential portion 26 and outer circumferential portion 28. For example, in some embodiments, at least some of first ribs 40 are coupled to inner circumferential portion 26 and outer circumferential portion 28 and extend therebetween, as shown in FIG. 2. Similarly, in some embodiments, support structure 34 includes a plurality of second ribs 42 extending in a second circumferential direction opposite the first circumferential direction between inner circumferential portion 26 and outer circumferential portion 28. For example, in some embodiments, at least some of second ribs 42 are coupled to inner circumferential portion 26 and outer circumferential portion 28 and extend therebetween, as shown in FIG. 2. According to some embodiments, at least some of first ribs 40 and some of second ribs 42 intersect one another such that they share common material at points of intersection. In addition, at least some of first ribs 40 and at least some of second ribs 42 form cavities 33 in support structure 36.

As shown in FIG. 2, according to some embodiments, each of first ribs 40 may have a cross-section perpendicular to the axial direction having a first curvilinear shape. In some embodiments, the first curvilinear shape may be a curve having a single direction of curvature (see, e.g., FIG. 2) as first ribs 40 extend between inner circumferential portion 26 and outer circumferential portion 28. In some embodiments, the first curvilinear shape may be a curve having a direction of curvature that changes once as first ribs 40 extend between inner circumferential portion 26 and outer circumferential portion 28. Similarly, each of second ribs 42 may have a cross-section perpendicular the axial direction of tire 24 having a second curvilinear shape. In some embodiments, the second curvilinear shape may be a curve having a single direction of curvature (see, e.g., FIG. 2) as second ribs 42 extend between inner circumferential portion 26 and outer circumferential portion 28. In some embodiments, the second curvilinear shape may be a curve having a direction of curvature that changes once as second ribs 42 extend between inner circumferential portion 26 and outer circumferential portion 28.

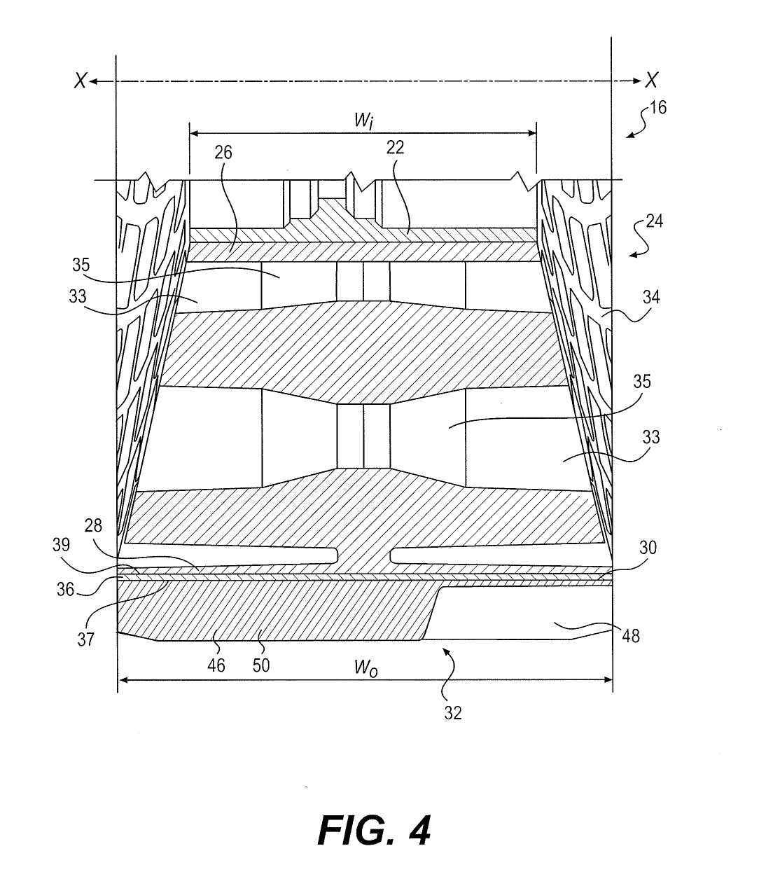

Tire 24 may have dimensions tailored to the desired performance characteristics based on the expected use of the tire. For example, exemplary tire 24 may have an inner diameter ID for coupling with hub 22 ranging from 0.5 meter to 4 meters (e.g., 2 meters), and an outer diameter OD ranging from 0.75 meter to 6 meters (e.g., 4 meters) (see FIG. 2). According to some embodiments, the ratio of the inner diameter of tire 24 to the outer diameter of tire 24 ranges from 0.25:1 to 0.75:1, or 0.4:1 to 0.6:1, for example, about 0.5:1. Support structure 34 may have an inner axial width Wᵢ at inner circumferential portion 26 (see FIGS. 3 and 4) ranging from 0.05 meter to 3 meters (e.g., 0.8 meter), and an outer axial width Wₒ at outer circumferential portion 28 ranging from 0.1 meter to 4 meters (e.g., 1 meter). For example, exemplary tire 24 may have a trapezoidal cross-section (see FIG. 3). Other dimensions are contemplated. For example, for smaller machines, correspondingly smaller dimensions are contemplated.

According to some embodiments, tread portion 32 is formed from a first polyurethane having first material characteristics, and support structure 34 is formed from a second polyurethane having second material characteristics different than the first material characteristics. According to some embodiments, tread portion 32 is chemically bonded to support structure 34. For example, at least some of the first polyurethane of tread portion 32 is covalently bonded to at least some of the second polyurethane of support structure 34. This may result in a superior bond as compared with bonds formed via adhesives, mechanisms, or fasteners.

As a result of the first material characteristics of the first polyurethane being different than the second material characteristics of the second polyurethane, it may be possible to tailor the characteristics of tread portion 32 and support structure 34 to characteristics desired for those respective portions of tire 24. For example, the second polyurethane of support structure 34 may be selected to be relatively stiffer and/or stronger than the first polyurethane of tread portion 32, so that support structure 34 may have sufficient stiffness and strength to support the anticipated load on tires 24. According to some embodiments, the first polyurethane of tread portion 32 may be selected to be relatively more cut-resistant and wear-resistant and/or have a higher coefficient of friction than the second polyurethane, so that regardless of the second polyurethane selected for support structure 34, tread portion 32 may provide the desired wear and/or traction characteristics for tire 24.

For example, the first polyurethane of tread portion 32 may include polyurethane urea materials based on one or more of polyester, polycaprolactone, and polycarbonate polyols that may provide relatively enhanced abrasion resistance. Such polyurethane urea materials may include polyurethane prepolymer capped with methylene diisocyanate (MDI) that may strongly phase segregate and form materials with relatively enhanced crack propagation resistance. Alternative polyurethanes capped with toluene diisocyanate (TDI), napthalene diisocyanate (NDI), and/or para-phenylene diisocyanate (PPDI) may also be used. Such polyurethane prepolymer materials may be cured with aromatic diamines that may also encourage strong phase segregation. Exemplary aromatic diamines include methylene diphenyl diamine (MDA) that may be bound in a salt complex such as tris(4,4′-diamino-diphenyl methane) sodium chloride (TDDM).

According to some embodiments, the first polyurethane may have a Shore hardness ranging from about from 60A to about 60D (e.g., 85 Shore A). For certain applications, such as those with soft ground conditions, it may be beneficial to form tread portion 32 from a material having a relatively harder durometer to generate sufficient traction through tread penetration. For applications such as those with hard or rocky ground conditions, it may be beneficial to form tread portion 32 from a material having a relatively lower durometer to allow conformability of tread portion 32 around hard rocks.

According to some embodiments, the second polyurethane of support structure 34 may include polyurethane urea materials based on one or more of polyether, polycaprolactone, and polycarbonate polyols that may provide relatively enhanced fatigue strength and/or a relatively low heat build up (e.g., a low tan δ). For example, for high humidity environments it may be beneficial for the second polyurethane to provide a low tan δ for desired functioning of the tire after moisture absorption. Such polyurethane urea materials may include polyurethane prepolymer capped with methylene diisocyanate (MDI) that may strongly phase segregate and form materials having relatively enhanced crack propagation resistance, which may improve fatigue strength. Alternative polyurethanes capped with toluene diisocyanate (TDI), napthalene diisocyanate (NDI), or para-phenylene diisocyanate (PPDI) may also be used. Such polyurethane prepolymer materials may be cured with aromatic diamines that may also encourage strong phase segregation. Exemplary aromatic diamines include methylene diphenyl diamine (MDA) that may be bound in a salt complex such as tris(4,4′-diamino-diphenyl methane) sodium chloride (TDDM). Chemical crosslinking in the polyurethane urea may provide improved resilience to support structure 34. Such chemical crosslinking may be achieved by any means known in the art, including but not limited to: the use of tri-functional or higher functionality prepolymers, chain extenders, or curatives; mixing with low curative stoichiometry to encourage biuret, allophanate, or isocyanate formation; including prepolymer with secondary functionality that may be cross-linked by other chemistries (e.g., by incorporating polybutadiene diol in the prepolymer and subsequently curing such with sulfur or peroxide crosslinking). According to some embodiments, the second polyurethane of support structure 34 (e.g., a polyurethane urea) may have a Shore hardness ranging from about 80A to about 95 A (e.g., 92A).

As shown in FIG. 4, some embodiments of tire 24 may include an intermediate portion 36 between outer circumferential portion 28 and inner surface 30 of tread portion 32. For example, in the exemplary embodiment shown in FIG. 4, outer circumferential portion 28 of support structure 34 may be chemically bonded to inner surface 30 of tread portion 32 via intermediate portion 36 as explained in more detail below. For example, intermediate portion 36 may have an outer circumferential surface 37 chemically bonded to inner surface 30 of tread portion 32, and an inner circumferential surface 39 chemically bonded to outer circumferential portion 28 of support structure 34.

According to some embodiments, intermediate portion 36 may be formed from a third polyurethane. According to some embodiments, the third polyurethane may be at least similar (e.g., the same) chemically to either the first polyurethane or the second polyurethane. According to some embodiments, the third polyurethane may be chemically different than the first and second polyurethanes. For example, according to some embodiments, the third polyurethane may be mixed with a stoichiometry that is prepolymer rich (e.g., isocyanate rich). That is, in a polyurethane urea system there is a theoretical point where each isocyanate group will react with each curative (amine) functional group. Such a point would be considered to correspond to a stoichiometry of 100%. In a case where excess curative (diamine) is added, the stoichiometry would be considered to be greater than 100%. In a case where less curative (diamine) is added, the stoichiometry would be considered to be less than 100%. For example, if a part is formed with a stoichiometry less than 100%, there will be excess isocyanate functionality remaining in the part. Upon high temperature postcuring of such a part (e.g., subjecting the part to a second heating cycle following an initial, incomplete curing), the excess isocyanate groups will react to form urea linkages, biuret linkages, and isocyanurates through cyclo-trimerization, or crosslinks through allophanate formation. According to some embodiments, the third polyurethane may be chemically similar to the support structure 34 polyurethane, but formulated to range from about 50% to about 90% of theoretical stoichiometry (i.e., from about 50% to about 90% “stoichiometric”) (e.g., from about 60% to about 80% stoichiometric (e.g., about 75% stoichiometric)). Such polyurethane urea, even after forming an initial structure following so-called “green curing,” is still chemically active through the excess isocyanate functional groups.

In such embodiments, the third polyurethane may be molded into a self-supporting shape and thereafter continue to maintain its ability to chemically react or bond with the first and second polyurethanes, even if the first and second polyurethanes are substantially stoichiometric, by postcuring the first, second, and third polyurethanes together, for example, at a temperature of greater than at least about 150° C. (e.g., greater than at least about 160° C.) for a duration ranging from about 6 hours to about 18 hours (e.g., from 8 hours to 16 hours). A self-supporting intermediate portion 36 of third polyurethane may be inserted into a mold for forming tire 24, and the first and second polyurethanes may be supplied to the mold on either side of intermediate portion 36, such that intermediate portion 36 is embedded in tire 24 between tread portion 32 and support structure 34. According to some embodiments, the first and second polyurethanes are substantially stoichiometric prior to curing (e.g., from about 95% to about 98% stoichiometric).

According to some embodiments, intermediate portion 36 may have a different color than one or more of tread portion 32 and support structure 34. This may provide a visual indicator of the wear of tread portion 32. This may also provide a visual indicator when shaving or milling tread portion 32 during a process of retreading tire 24 with a new tread portion. For example, as explained in more detail below, when tread portion 32 becomes undesirably worn, the remaining material of tread portion 32 may be shaved or milled off down to intermediate portion 36, so that a new tread portion can be molded onto intermediate portion 36 of tire 24. By virtue of intermediate portion 36 being a different color than tread portion 32, it may be relatively easier to determine when sufficient shaving or milling has occurred to expose intermediate portion 36.

According to some embodiments, intermediate portion 36 may include a semi-permeable membrane configured to permit chemical bonding between the first polyurethane and the second polyurethane. For example, the first polyurethane and the second polyurethane may be covalently bonded to one another via (e.g., through) the semi-permeable membrane. For example, intermediate portion 36 may include at least one of fabric and paper, such as, for example, flexible filter paper (e.g., a phenolic-impregnated filter paper) or an elastic fabric such as, for example, SPANDEX®. The fabric or paper may be supported in a mold for forming tire 24 via a frame such as spring-wire cage, and the first and second polyurethanes may be supplied to the mold on either side of the fabric or paper of intermediate portion 36, such that intermediate portion 36 is embedded in tire 24 between tread portion 32 and support structure 34.

As shown in FIGS. 2-4, tread portion 32 may be provided to improve the traction provided by tire 24. For example, exemplary tread portion 32 includes a predetermined pattern 44 of protrusions 46 and recesses 48. Exemplary predetermined pattern 44 includes a plurality of tread blocks 50 separated circumferentially from one another by a plurality of transverse- or axially-extending grooves 52 and a plurality of circumferentially-extending channels 53. Predetermined pattern 44 may be configured to provide a desired level of traction depending on, for example, the terrain over which machine 10 is intended to travel.

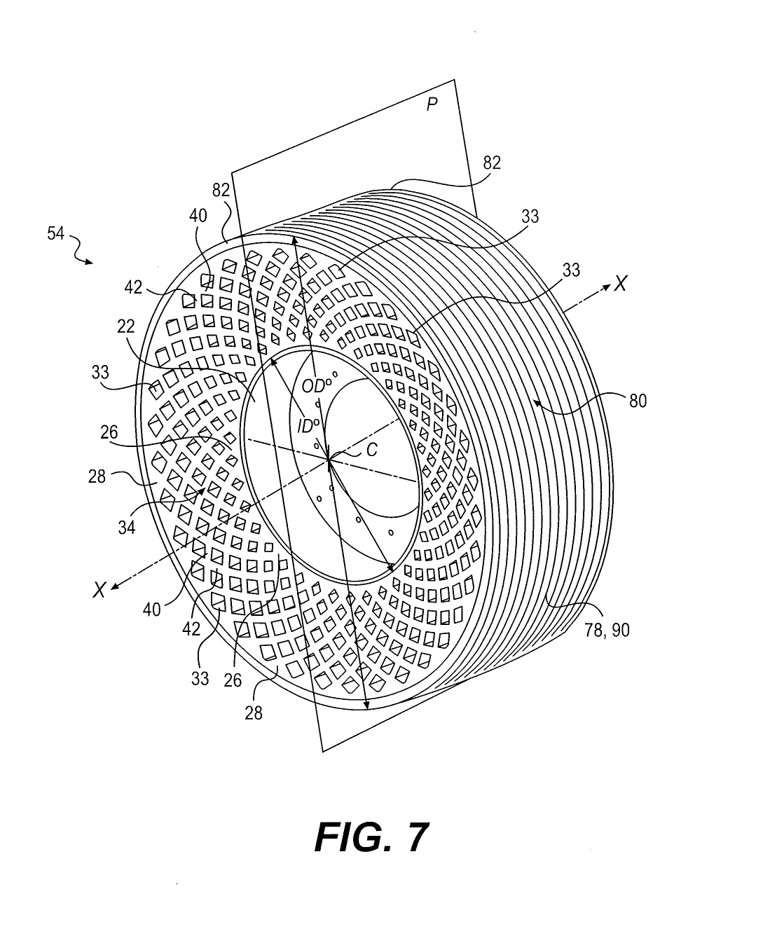

With use, tread portion 32 may become damaged or worn to a point where it no longer provides a desirable amount of traction. Alternatively, it may be desirable to have a tread portion 32 with an alternative predetermined pattern 44. Thus, it may be desirable to replace or change tread portion 32, while continuing to use the same hub 22 and support structure 34, which may continue to be in a usable condition. As a result, it may be desirable to provide a core 54, for example, as shown in FIGS. 7-9, onto which a new tread portion 32 may be formed, for example, via molding tread portion 32 onto core 54.

When molding a new tread portion onto core 54, it may be desirable for core 54 to be in a condition that facilitates the molding of a new tread portion onto outer circumferential portion 28. In order to form a more durable and acceptable new tread portion, it may be desirable to remove any remaining tread portion 32 from tire 24 to provide a surface more receptive to the new tread portion, such that the new tread portion is securely fixed onto outer circumferential portion 28.

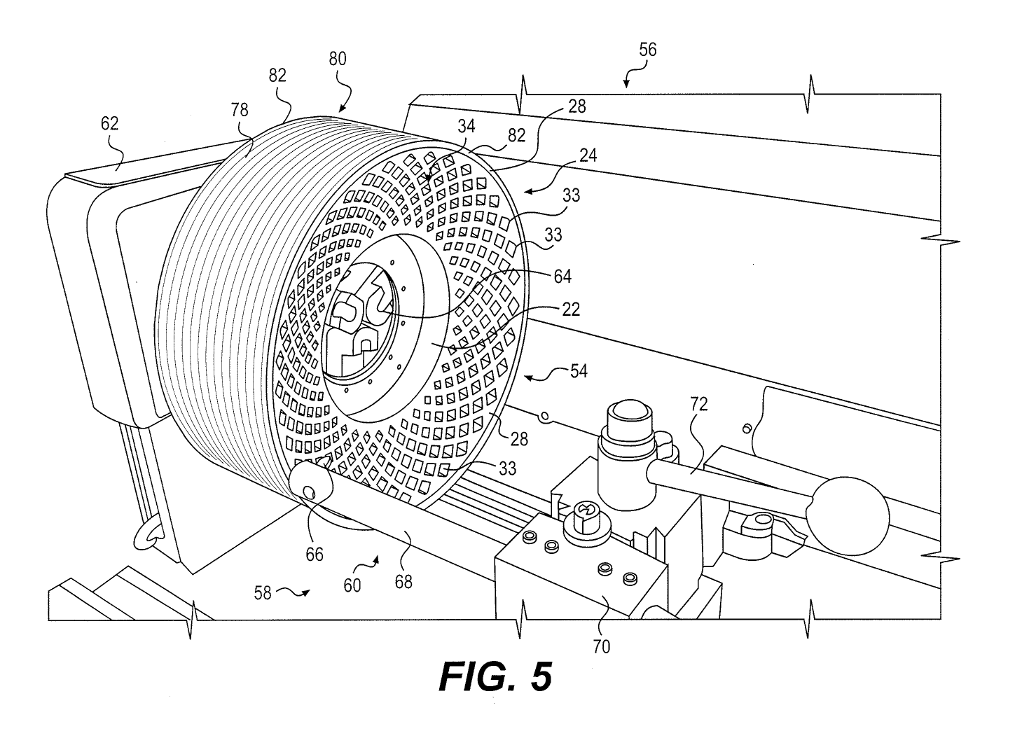

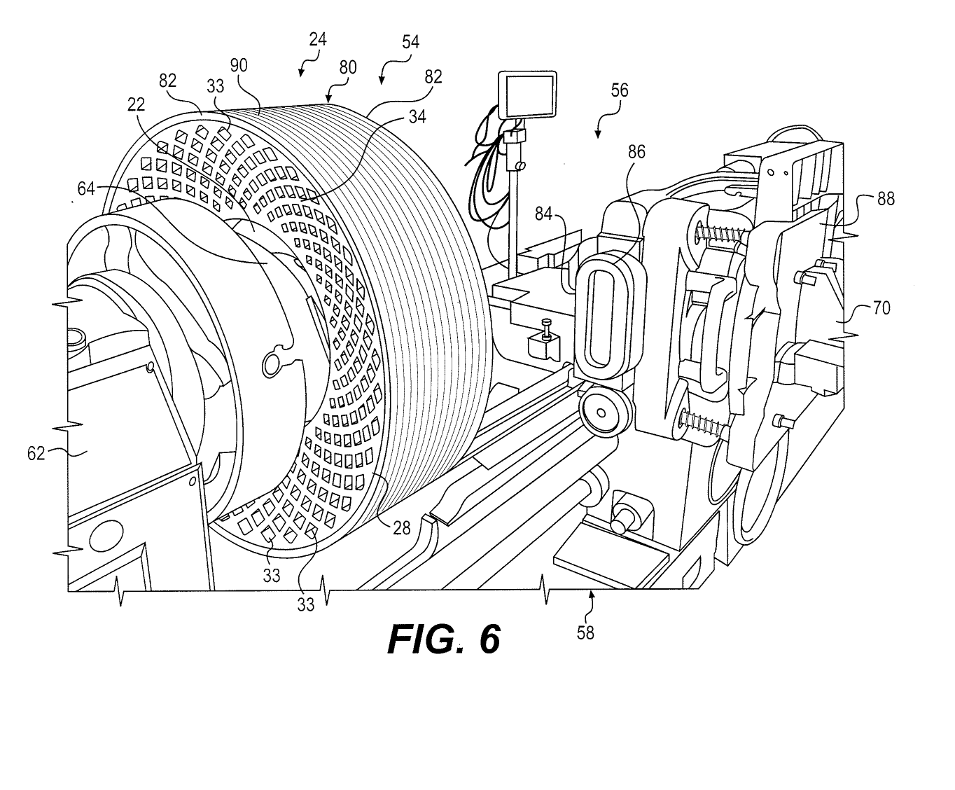

FIGS. 5 and 6 show two exemplary machines 56 for removing at least a portion of remaining tread portion 32 from a tire 24 being converted into a core 54 for receiving a new tread portion. As shown in FIG. 5, exemplary machine 56 includes a lathe 58 having an axially-travelling table 60. Exemplary table 60 includes a housing 62 containing a motor and drive unit (not shown) configured to rotate a chuck 64 configured to hold and rotate a tire about its axis of rotation during operation. Exemplary lathe 58 also includes a motor for causing housing 62 and chuck 64 to move axially down table 60 while chuck 64 and tire 24 rotate. According to some embodiments, chuck 64 may be configured to hold a tire (e.g., via hub 22), such that a rotating axis of chuck 64 and the axis of rotation X of tire 24 are concentric with one another. For example, chuck 64 may be a three-jaw or four-jaw chuck that provides adjustability for aligning tire 24 with chuck 64. For example, a measuring device, such as an indicator, may be used to measure the run-out of the outer surface of tire 24 as it rotates with chuck 64, and the position of tire 24 in chuck 64 may be adjusted to minimize the run-out.

Exemplary machine 56 shown in FIG. 5 includes a stationary cutter 66. Exemplary stationary cutter 66 is held in position by a boring bar 68 mounted in a cross-slide 70. Boring bar 68 is configured to hold stationary cutter 66 in a substantially stationary position. Exemplary cross-slide 70 includes an adjustment handle 72 configured to be loosened and tightened during adjustment of the position of stationary cutter 66 via boring bar 68. According to some embodiments, stationary cutter 66 may be a sharp, high-speed steel cutter configured to cut away material rather than tear away material. Other cutters are contemplated.

During exemplary operation, motor and drive unit are activated such that tire 24 rotates about its axis of rotation, and chuck 64 and tire 24 travel axially down table 60. Stationary cutter 66 is adjusted so that stationary cutter 66 removes material from the surface of tire 24 as tire 24 travels past stationary cutter 66. As a result of this exemplary cutting, a portion of tread portion 32 is removed with each pass of tire 24 past stationary cutter 66, thereby forming a generally shallow, circumferential, spiral groove 78 in the surface of tread portion 32, for example, as shown in FIG. 5, which shows an exemplary tire 24 after removal of at least a first layer of material from tread portion 32. After a first pass of tire 24, the position of stationary cutter 66 may be adjusted so that upon the next pass of tire 24, additional material is removed from tread portion 32. This process may be repeated until a desired amount of tread portion 32 is removed from tire 24, resulting in core 54.

According to some embodiments, the following exemplary method may be used to form core 54 from a tire 24. Tire 24 may be cleaned to remove debris such as rocks, nails, wire, dirt, and mud from remaining tread portion 32 and/or support structure 34. Hub 22 may be checked for damage that may indicate the need for replacement. Thereafter, hub 22 may be mounted in chuck 64 such that run-out of the outer surface of tire 24 is minimized. Thereafter, machine 56 may be operated such that the surface of remaining tread portion 32 is cut away with stationary cutter 66 as tire 24 passes stationary cutter 66. According to some embodiments, the depth of cut for each pass may range from about 0.050 inches to about 0.500 inches and a feed rate ranging from about 0.020 inches to about 0.250 inches per revolution, with a motor speed ranging from about 20 to about 40 revolutions per minute, for example, for a tire having a 32-inch diameter. For larger tires, the motor would be operated such that the surface speed of the surface of remaining tread portion ranges from about 250 to about 700 feet per minute. Repetitive passes may be made until tread portion 32 is removed down to a desired diameter of tire 24 to form core 54, for example, to a diameter corresponding to about halfway between the diameter corresponding to the end of tread portion 32 and the diameter corresponding to where cavities 33 begin in support structure 34.

For example, according to an exemplary method of forming core 54 of a non-pneumatic tire 24, with core 54 being configured to have a new tread formed thereon, the method may include mounting tire 24 in lathe 58. The method may further include activating lathe 58 such that tire 24 rotates about its axis of rotation. The method may also include applying a cutter against a surface of tire 24, such that the cutter removes material from tire 24. The method may further include continuing to apply the cutter against tire 24 until outer circumferential portion 28 of tire 24 has a radially outward facing surface 80 having a substantially constant diameter spanning between opposed, axially-spaced side edges 82 of outer circumferential portion 28. According to some embodiments of the method, mounting tire 24 in lathe 58 includes mounting tire 24 in a four-jaw chuck, such that an axis of rotation of chuck 64 is concentric with an axis of rotation of tire 24. According to some embodiments, the cutter is a stationary cutter, and applying the stationary cutter against the surface of tire 24 includes moving tire 24 axially such that the stationary cutter removes material from tire 24 circumferentially as tire 24 moves axially past the stationary cutter. According to some embodiments, the stationary cutter removes material from tire 24 circumferentially in a spiral as tire 24 moves axially the past stationary cutter.

According to the exemplary embodiment show in in FIG. 6, machine 56 includes a rotating cutter 84 rather than a stationary cutter, as shown in FIG. 5. For example, exemplary machine 56 includes lathe 58 having axially-travelling table 60. Exemplary table 60 includes housing 62 containing a motor and drive unit (not shown) configured to rotate chuck 64 configured to hold and rotate a tire about its axis of rotation during operation. Exemplary lathe 58 also includes a motor for causing housing 62 and chuck 64 to move axially down table 60 while chuck 64 and tire 24 rotate. According to some embodiments, chuck 64 may be configured to hold tire 24 (e.g., via hub 22), such that a rotating axis of chuck 64 and the axis of rotation X of tire 24 are concentric with one another. Chuck 64 may be a three jaw or four-jaw chuck that provides adjustability for aligning tire 24 with chuck 64.

Exemplary rotating cutter 84 shown in FIG. 6 is part of a planer head 86. According to some embodiments, planer head 86 may include a plurality of rotating cutters 84 arranged in an adjacent manner, such that the effective width of the rotating cutter 84 is increased relative to a single rotating cutter. According to some embodiments, rotating cutter(s) 84 may be sharp, high-speed steel cutter(s) configured to cut away material rather than tear away material. Other cutters are contemplated.

According to some embodiments, for example, as shown in FIG. 6, planer head 86 is a conventional planer head mounted for use with lathe 58. As shown in FIG. 6, planer head 86 is mounted on a bracket 88 and coupled to cross-slide 70 of lathe 58, such that rotating cutter 84 is able to be applied against tire 24 as tire 24 rotates in chuck 64. For example, according to some embodiments, a method of forming core 54 may include mounting non-pneumatic tire 24 in lathe 58. The method may further include activating lathe 58 such that tire 24 rotates about its axis of rotation. The method may also include applying rotating cutter 84 against a surface of tire 24 such that rotating cutter 84 removes material from tire 24. The method may further include continuing to apply rotating cutter 84 against tire 24 until outer circumferential portion 28 of tire 24 has a radially outward facing surface 80 having a substantially constant diameter spanning between opposed, axially-spaced side edges 82 of outer circumferential portion 28. For example, applying rotating cutter 84 against the surface of tire 24 includes moving tire 24 axially via table 60 of lathe 58 to a position opposite rotating cutter 84, and moving rotating cutter 84 such that it removes material from tire 24 as it rotates. According to some embodiments, tire 24 and rotating cutter 84 rotate in substantially the same plane and the same direction, such that the surface of tire 24 and rotating cutter 84 are moving in opposite directions at a point of contact between the surface and rotating cutter 84. According to some embodiments, rotating cutter 84 removes material from tire 24 circumferentially, forming generally shallow, circumferential grooves 90, as shown in FIG. 6.

According to some embodiments, a method using rotating cutter 84 includes slowly feeding rotating tire 24 against rotating cutter 84 to remove relatively thin slices of material across the width of tire 24 at outer circumferential portion 28 between side edges 82, for example, until tread portion 32 is removed down to a desired diameter of tire 24 to form core 54, for example, to a diameter corresponding to about halfway between the diameter corresponding to the end of tread portion 32 and the diameter corresponding to where cavities 33 begin in support structure 34.

According to some embodiments, the method may include sequentially using a stationary cutter and then using a rotating cutter. For example, a stationary cutter may be used to remove a portion of the material of the tread portion, and the rotating cutter may be used remove the remaining material desired to be removed. Use of the rotating cutter may be desirable, for example, when the tire has a relatively narrow thickness of material between the tread portion and the cavities in the support structure.

FIGS. 7-9 show exemplary embodiments of a core 54 of a tire 24 (e.g., a non-pneumatic tire 24) configured to have tread formed thereon. For example, as shown in FIGS. 7-9, core 54 may include hub 22 configured to be coupled to machine 10 (e.g., see FIG. 1). Core 54 may also include inner circumferential portion 26 associated with hub 22, and outer circumferential portion 28 radially spaced from inner circumferential portion 26. As shown, outer circumferential portion 28 may extend axially between opposed, axially-spaced side edges 82 of core 54. Core 54 may also include support structure 34 extending between inner circumferential portion 26 and outer circumferential portion 28 and coupling inner circumferential portion 26 to outer circumferential portion 28. According to some embodiments, support structure 34 includes a plurality of first ribs 40 extending between inner circumferential portion 26 and outer circumferential portion 28, and at least some of first ribs 40 at least partially form cavities 33 in support structure 34. According to some embodiments, support structure 34 also includes a plurality of second ribs 42 extending between inner circumferential portion 26 and outer circumferential portion 28. According to the exemplary embodiments shown, at least some of first ribs 40 intersect at least some of second ribs 42, such that intersecting first ribs 40 and second ribs 42 share common material at points of intersection. According to some embodiments, at least some of first ribs 40 and at least some of second ribs 42 form cavities 33 in support structure 34. According to the exemplary embodiments shown, core 54 is substantially absent (e.g., completely absent) of tread including predetermined pattern 44 of at least one of protrusions 46 and recesses 48, such that outer circumferential portion 28 has a radially outward facing surface 80 having a substantially constant diameter OD (FIG. 7) spanning between side edges 82 of outer circumferential portion 28

As shown in FIG. 7, according to some embodiments, radially outward facing surface 80 of core 54 includes a plurality of circumferentially extending surface grooves resulting from a cutter, such as, for example, grooves 78 and/or 90 shown in FIGS. 5 and 6.

According to some embodiments of core 54, at least some of cavities 33 in support structure 34 are adjacent outer circumferential portion 28, such that radially outward facing surface 80 includes alternating regions that are relatively more flexible and relatively less flexible, for example, as shown in FIGS. 7-9.

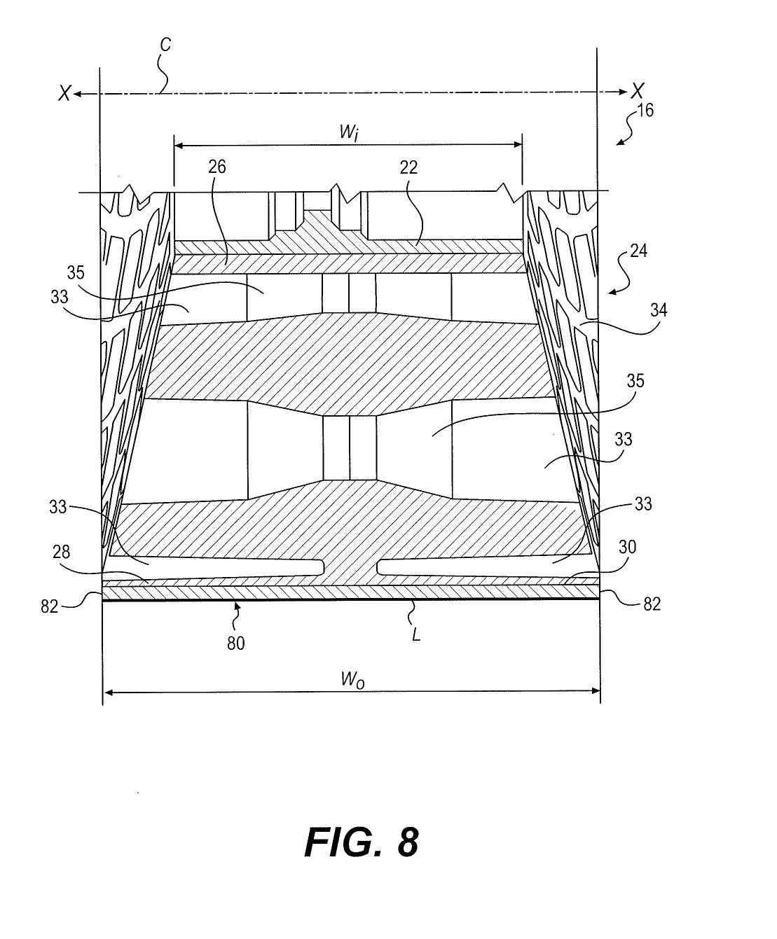

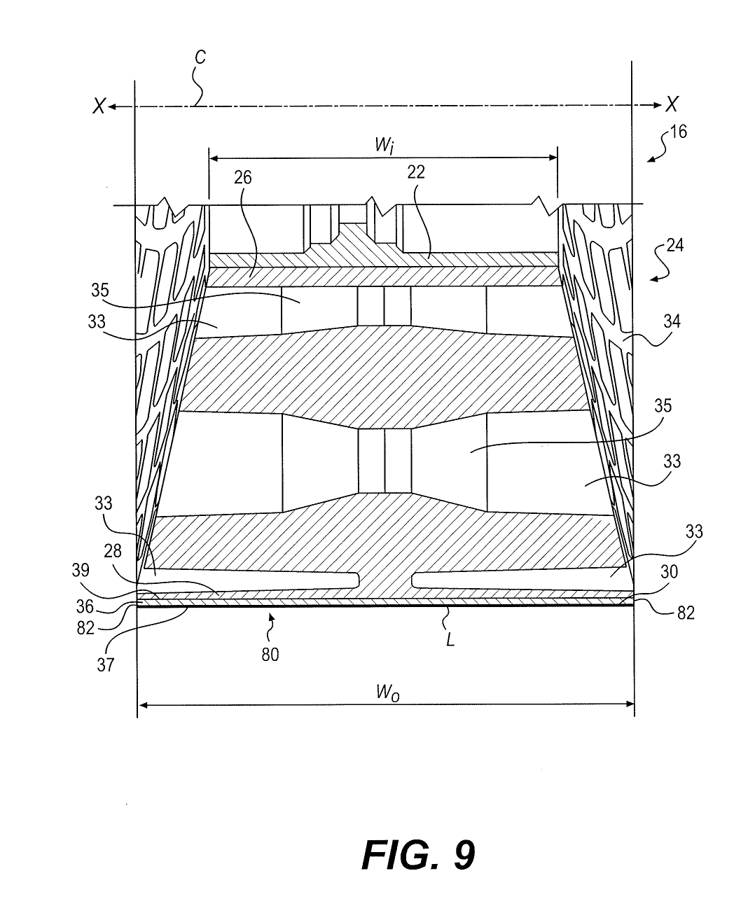

According to the exemplary embodiments shown in FIGS. 8 and 9, outer circumferential portion 28 has a cross-section substantially perpendicular to a radially extending plane P extending from a center C of core 54 toward outer circumferential portion 28 (see FIG. 7), and the cross-section of outer circumferential portion 28 at radially outward facing surface 80 forms a substantially straight line L (see FIGS. 8 and 9).

According to some embodiments, for example, as shown in FIG. 7, first ribs 40 have a cross-section substantially perpendicular to an axial direction of core 54, with the cross-section having a first curvilinear shape, wherein the first curvilinear shape is a curve having either a single direction of curvature (see FIG. 7) or a direction of curvature that changes once as first ribs 40 extend between inner circumferential portion 26 and outer circumferential portion 28. According some embodiments, at least some of first ribs 40 extend in a first circumferential direction, as shown in FIG. 7. According to some embodiments, at least some of second ribs 42 of core 54 extend in a second circumferential direction, opposite the first circumferential direction, as shown in FIG. 7. For example, second ribs 42 may have a second cross-section substantially perpendicular to the axial direction of core 54, with the second cross-section having a second curvilinear shape. The second curvilinear shape may be a curve having either a single direction of curvature (see FIG. 7) or a direction of curvature that changes once as second ribs 42 extend between inner circumferential portion 26 and outer circumferential portion 28.

According to some embodiments, support structure 34 may be at least partially formed from at least one polymer selected from the group consisting of polyurethane, natural rubber, and synthetic rubber, similar to tire 24. Other materials are contemplated for support structure 34. According to some embodiments, hub 22 may be at least partially formed from metal. Other materials are contemplated for hub 22.

### INDUSTRIAL APPLICABILITY

The non-pneumatic tires disclosed herein may be used with any machines, including self-propelled vehicles or vehicles intended to be pushed or pulled by another machine. According to some embodiments, the non-pneumatic tires may be molded, non-pneumatic tires having a tread portion formed integrally as a single piece with the remainder of the tire to form a single, monolithic structure. With use, the tread portion may become worn beyond a point rendering the tire unsuitable for its intended use. For a pneumatic tire, it is possible to merely remove the rubber tire portion from the wheel, and install a new rubber tire portion onto the wheel and inflate it, thereby acquiring a new tire having a desirable tread. However, unlike a pneumatic tire that is mounted on a wheel and inflated, it may be difficult or impractical to simply remove the portion of the non-pneumatic tire surrounding a hub and installing a new portion having a new tread, particularly if the non-pneumatic tire is molded as a single, monolithic structure.

According to some embodiments, the methods disclosed herein may facilitate removal of at least a portion of the tread portion, such that the remaining core is suitable for molding a new tread portion onto the core. For example, according to some embodiments, the resulting core may be substantially absent of tread, and may have a radially outward facing surface having a substantially constant diameter extending between side edges of the outer circumferential portion of the core. Such an outward facing surface may render the core more receptive to receiving and adhering securely to the material being molded onto the core to form the new tread portion. According to some embodiments, the outward facing surface may include a plurality of generally, shallow circumferentially extending grooves resulting from a cutter used to remove the worn tread portion. Such grooves may enhance adherence of the new tread portion to the core.

According to some embodiments, the outward facing surface may include alternating regions that are relatively more flexible and relatively less flexible. This alternating amount of flexibility is due the support structure of the molded tire having cavities, with the cavities adjacent the outward facing surface resulting in outward facing surface being relatively more flexible in the regions adjacent the cavities. Such disparities in flexibility may render it difficult to remove the worn tread portion from the remainder of the tire. For example, the relatively more flexible regions of the outward facing surface may tend to deflect rather than be cut with the cutter.

According to some embodiments, the methods of forming a core disclosed herein may overcome the alternating flexibility condition. For example, the use of a sharp, high-speed steel cutter (either stationary or rotational) mounted to a lathe may result in cutting away the material of the worn tread portion even in regions having more flexibility. For example, the use of a rotational cutter, such as a planer head, may result in removing material from the more flexible regions instead of merely deflecting those regions.

Following removal of the worn tread portion to form a core, a new tread portion may be molded onto the outward facing surface of the core. This may be accomplished by, for example, placing the core in a mold having mold pieces configured to form a tread portion on the core, adding the molding material to the mold, curing the molding material, and removing the tire from the mold. Such a process may result in the ability to recycle the non-tread portion of a non-pneumatic tire when the tread portion is worn instead of disposing of the entire non-pneumatic tire.

It will be apparent to those skilled in the art that various modifications and variations can be made to the exemplary disclosed tires and methods of forming molded tires. Other embodiments will be apparent to those skilled in the art from consideration of the specification and practice of the exemplary disclosed embodiments. It is intended that the specification and examples be considered as exemplary only, with a true scope being indicated by the following claims and their equivalents.

What is claimed is:

1. A core of a non-pneumatic tire, the core being configured to have a tread formed thereon and comprising:
a hub configured to be coupled to a machine;
an inner circumferential portion associated with the hub;
an outer circumferential portion radially spaced from the inner circumferential portion, the outer circumferential portion extending between opposed, axially-spaced side edges; and
a support structure extending between the inner circumferential portion and the outer circumferential portion and coupling the inner circumferential portion to the outer circumferential portion, wherein the support structure includes a plurality of first ribs extending between the inner circumferential portion and the outer circumferential portion, and wherein at least some of the first ribs at least partially form cavities in the support structure, and
wherein the core is substantially absent of tread including a predetermined pattern of at least one of protrusions and recesses, such that the outer circumferential portion has a radially outward facing surface having a substantially constant diameter spanning between the side edges of the outer circumferential portion.

2. The core of claim 1, wherein the radially outward facing surface includes a plurality of circumferentially extending surface grooves resulting from a cutting tool.

3. The core of claim 1, wherein at least some of the cavities in the support structure are adjacent the outer circumferential portion, such that the radially outward facing surface includes alternating regions that are relatively more flexible and relatively less flexible.

4. The core of claim 1, wherein the outer circumferential portion has a cross-section substantially perpendicular to a radially extending plane extending from a center of the core toward the outer circumferential portion, and wherein the cross-section of the outer circumferential portion at the radially outward facing surface forms a substantially straight line.

5. The core of claim 1, further including a plurality of second ribs extending between the inner circumferential portion and the outer circumferential portion, wherein at least some of the first ribs intersect at least some of the second ribs, such that intersecting first ribs and second ribs share common material at points of intersection, and wherein at least some of the first ribs and at least some of the second ribs form cavities in the support structure.

6. The core of claim 5, wherein the first ribs have a cross-section substantially perpendicular to an axial direction of the core, with the cross-section having a first curvilinear shape, wherein the first curvilinear shape is a curve having either a single direction of curvature or a direction of curvature that changes once as the first ribs extend between the inner circumferential portion and the outer circumferential portion, wherein at least some of the first ribs extend in a first circumferential direction, and wherein at least some of the second ribs extend in a second circumferential direction.

7. The core of claim 6, wherein the second ribs have a second cross-section substantially perpendicular to the axial direction of the core, with the second cross-section having a second curvilinear shape, wherein the second curvilinear shape is a curve having either a single direction of curvature or a direction of curvature that changes once as the second ribs extend between the inner circumferential portion and the outer circumferential portion.

8. The core of claim 1, wherein the support structure is at least partially formed from at least one polymer selected from the group consisting of polyurethane, natural rubber, and synthetic rubber.

9. The core of claim 8, wherein the hub is at least partially formed from metal.

10. A core of a non-pneumatic tire, the core being configured to have a tread formed thereon and comprising:
a hub configured to be coupled to a machine;
an inner circumferential portion associated with the hub;
an outer circumferential portion radially spaced from the inner circumferential portion, the outer circumferential portion extending between opposed, axially-spaced side edges; and
a support structure extending between the inner circumferential portion and the outer circumferential portion and coupling the inner circumferential portion to the outer circumferential portion, wherein the support structure includes a plurality of first ribs extending between the inner circumferential portion and the outer circumferential portion, and wherein at least some of the first ribs at least partially form cavities in the support structure, and
wherein at least some of the cavities in the support structure are adjacent the outer circumferential portion, such that a radially outward facing surface of the core includes alternating regions that are relatively more flexible and relatively less flexible.

11. The core of claim 10, wherein the radially outward facing surface includes a plurality of circumferentially extending surface grooves resulting from a cutter.

12. The core of claim 10, wherein the outer circumferential portion has a cross-section substantially perpendicular to a radially extending plane extending from a center of the core toward the outer circumferential portion, and wherein the cross-section of the outer circumferential portion at the radially outward facing surface forms a substantially straight line.

13. The core of claim 10, wherein the first ribs have a cross-section substantially perpendicular to an axial direction of the core, with the cross-section having a first curvilinear shape, wherein the first curvilinear shape is a curve having either a single direction of curvature or a direction of curvature that changes once as the first ribs extend between the inner circumferential portion and the outer circumferential portion, and wherein at least some of the first ribs extend in a first circumferential direction.

14. A method of forming a core of a non-pneumatic tire, the core being configured to have a tread formed thereon, the method comprising:
mounting a non-pneumatic tire in a lathe;
activating the lathe such that the tire rotates about an axis of rotation of the tire;
applying a cutter against a surface of the tire such that the cutter removes material from the tire; and
continuing to apply the cutter against the tire until an outer circumferential portion of the tire has a radially outward facing surface having a substantially constant diameter spanning between opposed, axially-spaced side edges of the outer circumferential portion.

15. The method of claim 10, wherein mounting the tire in the lathe includes mounting the tire in a four-jaw chuck such that an axis of rotation of the chuck is substantially concentric with an axis of rotation of the tire.

16. The method of claim 10, wherein the cutter is a stationary cutter, and applying the stationary cutter against the surface of the tire includes moving the tire axially such that the stationary cutter removes material from the tire circumferentially as the tire moves axially past the stationary cutter.

17. The method of claim 16, wherein the stationary cutter removes material from the tire circumferentially in a spiral as the tire moves axially past the stationary cutter.

18. The method of claim 14, wherein the cutter includes at least one rotating cutter, and applying the rotating cutter against the surface of the tire includes moving the tire axially to a position opposite the rotating cutter and moving the rotating cutter such that the rotating cutter removes material from the tire as the tire rotates.

19. The method of claim 18, wherein the tire and the rotating cutter rotate in substantially the same plane and the same direction, such that the surface of the tire and the rotating cutter are moving in opposite directions at a point of contact between the surface and the rotating cutter.

20. The method of claim 14, wherein the non-pneumatic tire has at least a portion of tread including a predetermined pattern of at least one of protrusions and recesses, and wherein applying the cutter against the surface of the tire removes at least the portion of tread from the tire.
